(19) United States
(12) Patent Application Publication
(10) Pub. No.: US 2014/0292963 A1
(43) Pub. Date: Oct. 2, 2014

(54) INK JET DEVICE, INK CIRCULATING DEVICE, AND INK JET PRINTING APPARATUS

(71) Applicant: TOSHIBA TEC KABUSHIKI KAISHA, Tokyo (JP)

(72) Inventors: Kazuhiro HARA, Numazu (JP); Masashi HIROKI, Yokohama (JP); Hiroyuki ISHIKAWA, Kannami (JP)

(73) Assignee: TOSHIBA TEC KABUSHIKI KAISHA, Tokyo (JP)

(21) Appl. No.: 14/228,626

(22) Filed: Mar. 28, 2014

(30) Foreign Application Priority Data
Mar. 29, 2013 (JP) 2013-072330

(51) Int. Cl. B41J 2/185

(52) U.S. Cl. CPC B41J 2/185; B41J 2002/1853
USPC 347/89

(57) ABSTRACT

An ink jet device includes an ink jet head having a nozzle thorough which ink is discharged, an ink chamber communicating with the nozzle, an ink inlet from which the ink is supplied to the ink chamber, and an ink outlet from which the ink is recovered from the ink chamber, and an ink circulating unit having an ink tank that is in close proximity to the ink jet head and is connected to the ink inlet.

### CROSS-REFERENCE TO RELATED APPLICATION

This application is based upon and claims the benefit of priority from Japanese Patent Application No. 2013-072330, filed Mar. 29, 2013, the entire contents of which are incorporated herein by reference.

### FIELD

Embodiments described herein relate generally to an ink jet device, an ink circulating device for the inkjet device, and an ink jet printing apparatus.

### BACKGROUND

An ink jet device of a circulation type circulates ink that is supplied to an ink jet head. This type of ink jet device prevents ink from building up in the vicinity of nozzles and thus ink sedimentation and change in quality, to thereby improve reliability of ink ejection. Typically, the ink jet head of a circulation-type ink jet device is connected to an ink tank through a supply pipe for supplying ink to the ink jet head from the ink tank and a circulation pipe for recovering ink from the ink jet head to the ink tank. Conventionally, the ink tank is disposed away from the ink jet head. Thus, a long pipe is needed to connect to the ink tank.

### DESCRIPTION OF THE DRAWINGS

FIG. 1 is a side view of an ink jet printing apparatus according to an embodiment.

FIG. 2 is a front view of an ink jet device disposed in the ink jet printing apparatus according to the embodiment.

FIG. 3 is a back view of the ink jet device according to the embodiment.

FIG. 4 is a perspective plan view of an ink jet head of the ink jet device, showing the positional relationship between ink supplying ports, ink discharging ports, and ink grooves of actuators.

FIG. 5 is a cross-sectional view of the ink jet head taken along a line F5-F5 in FIG. 4.

FIG. 6 is a cross-sectional view of the ink jet head taken along a line F6-F6 in FIG. 5.

FIG. 7 is a front perspective view of the ink jet device.

FIG. 8 is an oblique perspective view of the ink jet device.

FIG. 9 is a side view of the ink jet device as viewed in the direction indicated by an arrow F9 in FIG. 2.

FIG. 10 is a side view of the ink jet device as viewed in the direction indicated by an arrow F10 in FIG. 2.

FIG. 11A is a cross-sectional view of a piezoelectric pump of the ink jet device at the time of suction of ink.

FIG. 11B is a cross-sectional view of the piezoelectric pump at the time of ejection of ink.

FIG. 12 is a cross-sectional view of a structure of a tube pump of the ink jet device.

### DETAILED DESCRIPTION

In general, an object of an exemplary embodiment is to provide an ink jet device capable of reducing the device size while allowing circulation of ink.

According to one embodiment, an ink jet device includes an ink jet head having a nozzle thorough which ink is discharged, an ink chamber communicating with the nozzle, an ink inlet from which the ink is supplied to the ink chamber, and an ink outlet from which the ink is recovered from the ink chamber, and an ink circulating unit having an ink tank that is in close proximity to the ink jet head and is connected to the ink inlet.

An exemplary embodiment is hereinafter described with reference to the drawings.

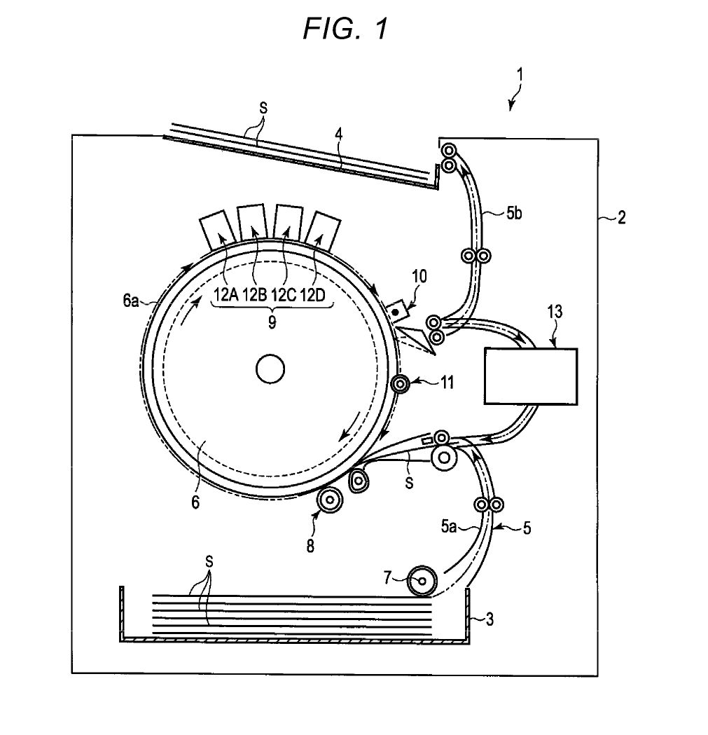

FIG. 1 schematically illustrates an example of an ink jet printing apparatus 1. The ink jet printing apparatus 1 includes a box-shaped housing 2. A sheet cassette 3, a sheet tray 4, a feeding path 5, and a holding drum 6 are accommodated in the housing 2.

The sheet cassette 3 is a component which accommodates sheets S as an example of a recording medium, and is disposed in the bottom part of the housing 2. The sheet tray 4 is provided in the upper part of the housing 2.

The feeding path 5 includes an upstream part 5a connected with the sheet cassette 3, and a downstream part 5b connected with the sheet tray 4. The sheets S accommodated in the sheet cassette 3 are fed one by one toward the upstream part 5a of the feeding path 5 by a roller 7.

The holding drum 6 is disposed between the sheet cassette 3 and the sheet tray 4 . The sheet S fed from the sheet cassette 3 to the upstream part 5a of the feeding path 5 is fed along an outer circumferential surface 6a of the holding drum 6, and guided toward the downstream part 5b of the feeding path 5. Specifically, the holding drum 6 is so structured as to rotate at a fixed speed in the circumferential direction while holding the sheet S on the outer circumferential surface 6a of the holding drum 6.

As illustrated in FIG. 1, a sheet pressing device 8, an image forming device 9, a neutralizing device 10, and a cleaning device 11 are provided around the holding drum 6.

The sheet pressing device 8 receives the sheet S supplied from the upstream part 5a of the feeding path 5 to the outer circumferential surface 6a of the holding drum 6, and presses the sheet S against the outer circumferential surface 6a of the holding drum 6. The sheet S pressed against the outer circumferential surface 6a of the holding drum 6 is attracted to the outer circumferential surface 6a of the holding drum 6 by electrostatic force.

The image forming device 9 is a component which forms an image on the sheet S attracted to the outer circumferential surface 6a of the holding drum 6. The image forming device 9 in this embodiment includes a first ink jet device 12A forming a cyan image, a second ink jet device 12B forming a magenta image, a third ink jet device 12C forming a yellow image, and a fourth ink jet device 12D forming a black image, for example.

The first through fourth ink jet devices 12A, 12B, 12C, and 12D are disposed along the rotational direction of the holding drum 6 while spaced apart from each other. The rotational direction of the holding drum 6 is also expressed as the feed direction of the sheet S along the outer circumferential surface 6a of the holding drum 6.

The neutralizing device 10 has a function of cancelling static electricity of the sheet S on which an image is formed, and separating the sheet S from the outer circumferential surface 6a of the holding drum 6 after the static electricity is cancelled. The sheet S separated from the outer circumferential surface 6a of the holding drum 6 is fed through the downstream part 5b of the feeding path 5, and guided toward the sheet discharging tray 4.

The cleaning device 11 has a function of cleaning the outer circumferential surface 6a of the holding drum 6 after the sheet S is separated therefrom. The cleaning device 11 is movable between a position contacting the outer circumferential surface 6a of the holding drum 6 and a position separated from the outer circumferential surface 6a of the holding drum 6.

Moreover, the ink jet printing apparatus 1 in this embodiment includes a turnover device 13 for turning over the front and rear surfaces of the sheet S. The turnover device 13 turns over the front and rear surfaces of the sheet S received after separated from the outer circumferential surface 6a of the holding drum 6 by the separating function of the neutralizing device 10, and returns the sheet S to the upstream part 5a of the feeding path 5. Accordingly, the sheet S of which front and rear are turned over is again supplied to the outer circumferential surface 6a of the holding drum 6, whereby a desired image is allowed to be formed on each of the front surface and the rear surface of the sheet S.

The first through fourth ink jet devices 12A, 12B, 12C, and 12D constituting an image forming device 9 basically have a common structure. In the description of this embodiment, therefore, the structure of the first ink jet device 12A is only discussed as a representative structure of the ink jet devices.

According to this embodiment, the plural first ink jet devices 12A are equipped, and disposed in a straight line or in a staggered line in the direction perpendicular to the feed direction of the sheet S, for example.

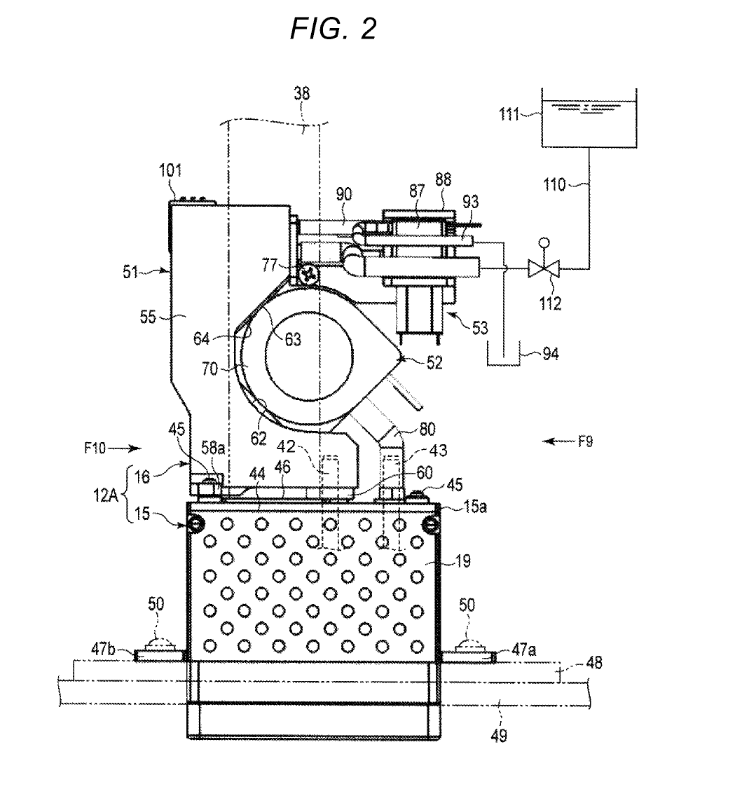

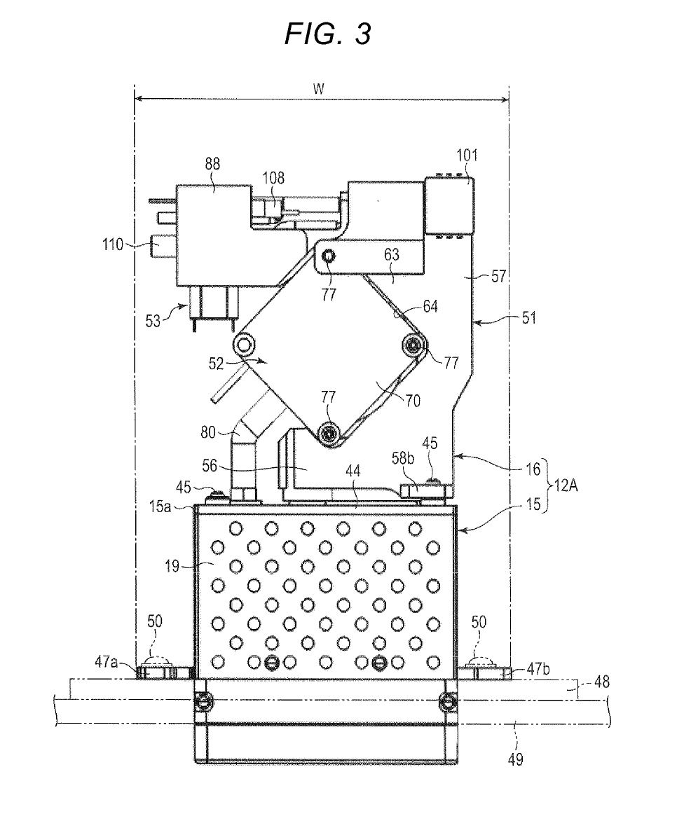

As illustrated in FIGS. 2 and 3, each of the ink jet devices 12A includes an ink-circulation-type ink jet head 15, and a closed-type ink circulating device 16. The ink jet head 15 includes a head main body 17, a manifold 18, and a head cover 19.

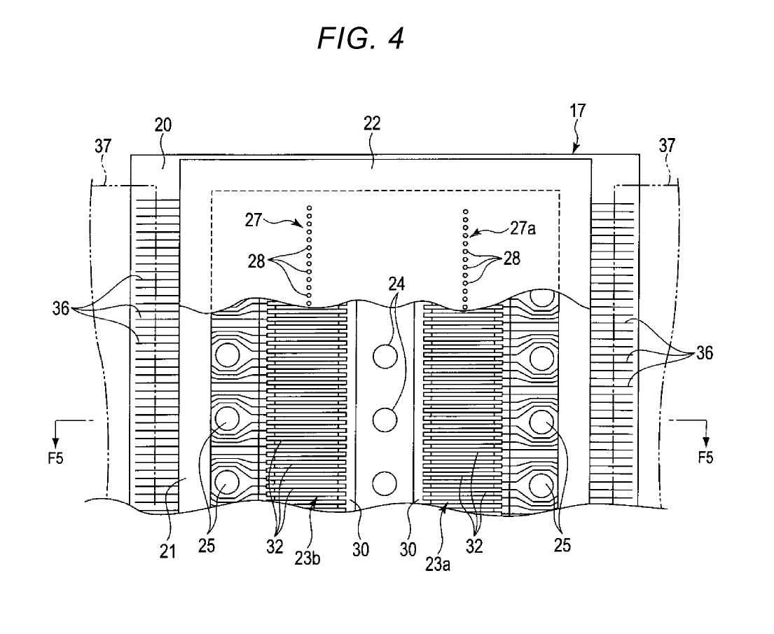

As illustrated in FIGS. 4 through 6, the head main body 17 includes a substrate 20, a frame member 21, a nozzle plate 22, and a pair of actuators 23a and 23b. The substrate 20 is a rectangular component which has a long, narrow, and flat lower surface 20a.

The substrate 20 includes a plurality of ink supplying ports 24 and a plurality of ink discharging ports 25. The ink supplying ports 24 are formed in the central part of the substrate 20 and arranged in a line in the longitudinal direction of the substrate 20 while spaced away from each other. The ink discharging ports 25 are arranged in two lines in the longitudinal direction of the substrate 20 while spaced away from each other in such positions that the ink supplying ports 24 are interposed between the ink discharging ports 25.

The frame member 21 is bonded to the lower surface 20a of the substrate 20 in such a position to surround the ink supplying ports 24 and the ink discharging ports 25. The nozzle plate 22 bonded to the frame member 21 faces to the lower surface 20a of the substrate 20.

As illustrated in FIG. 4, a pair of nozzle lines 27a and 27b is provided on the nozzle plate 22. The nozzle lines 27a and 27b are arranged so as to extend in the longitudinal direction of the nozzle plate 22 while spaced away from each other.

Each of the nozzle lines 27a and 27b includes a plurality of nozzles 28. The nozzles 28 are arranged in a line in the longitudinal direction of the nozzle plate 22 in each of the nozzle lines 27a and 27b while spaced away from each other. The substrate 20, the frame member 21, and the nozzle plate 22 create an ink chamber 29. Each of the ink supplying ports 24 and the ink discharging ports 25 is connected to the ink chamber 29.

Actuators 23a and 23b are disposed in the ink chamber 29. The actuator 23a on one side is bonded to the lower surface 20a of the substrate 20 at a position between the ink supplying ports 24 and the ink discharging ports 25. The actuator 23b on the other side is bonded to the lower surface 20a of the substrate 20 at a position between the ink supplying ports 24 and the ink discharging ports 25.

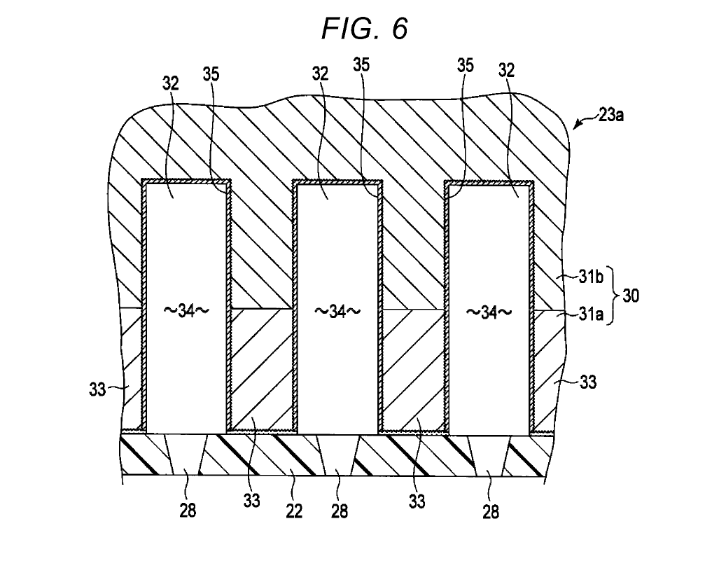

Each of the actuators 23a and 23b includes a long and narrow main body 30 extending along the nozzle line 27a or 27b. As illustrated in FIG. 6, each of the main bodies 30 includes two piezoelectric plates 31a and 31b. The piezoelectric plates 31a and 31b are affixed to each other such that the polarization directions of the respective plates 31a and 31b are opposite to each other in the thickness directions of the piezoelectric plates 31a and 31b.

As illustrated in FIGS. 4 through 6, a plurality of ink grooves 32 are formed in the main body 30. The ink grooves 32 are spaced apart from each other in the longitudinal direction of the main body 30, and successively open to the front surface and side surface of the main body 30. The portions of the main body 30 located between the respective ink grooves 32 function as partitioning walls 33 separating the adjoining ink grooves 32.

The nozzle plate 22 covers the opening ends of the ink grooves 32 opened to the front surface of the main body 30. The space defined by the ink grooves 32 and the nozzle plate 22 constitute a plurality of pressure chambers 34. The pressure chambers 34 communicate with the ink chamber 29 of the head main body 17.

Electrodes 35 are provided on the inner surfaces of the ink grooves 32 defining the pressure chambers 34. The electrodes 35 on the adjoining ink grooves 32 are separated from each other by the partitioning walls 33 in such a manner as to be electrically isolated from each other. The electrodes 35 include wiring patterns 36. The wiring patterns 36 are extended from the electrodes 35 to reach the lower surface 20a of the substrate 20 from the side surface of the main body 30.

The ends of the wiring patterns 36 are connected with a plurality of first flexible printed wiring boards 37 in an area outside the ink chamber 29. The first flexible printed wiring boards 37 are electrically connected with a printed circuit board which carries a driving circuit for driving the ink jet head 15. The printed circuit board is electrically connected with a second flexible printed wiring board 38 shown in FIG. 2.

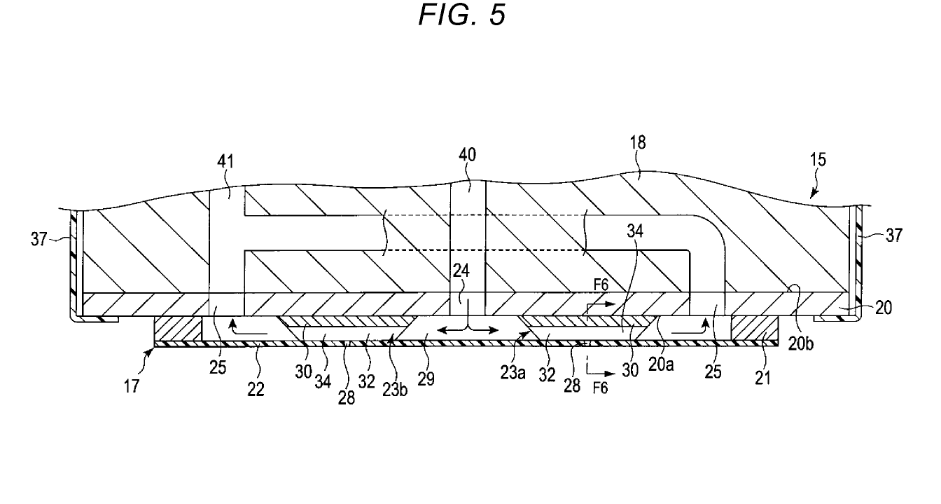

As illustrated in FIG. 5, the manifold 18 is fixed to an upper surface 20b of the substrate 20 of the head main body 17. The manifold 18 includes a distribution channel 40 through which ink is supplied to the ink supplying ports 24, and a circulation channel 41 into which ink discharged from the ink discharging ports 25 is introduced. The distribution channel 40 is connected with an ink supplying pipe 42. The circulation channel 41 is connected with an ink returning pipe 43. The ink supplying pipe 42 and the ink returning pipe 43 project from the manifold 18 toward above.

The head cover 19 has a square box shape, and surrounds the manifold 18, the first flexible printed wiring boards 37, the ink supplying pipe 42, and the ink returning pipe 43.

The upper end of the head cover 19 is closed by a resin top plate 44. The top plate 44 is fixed to the upper end of the head cover 19 by a plurality of screws 45. Accordingly, the top plate 44 is located on a side of the ink jet head 15 opposite a side on which the ink chamber 29 is formed, and constitutes an end 15a of the ink jet head 15.

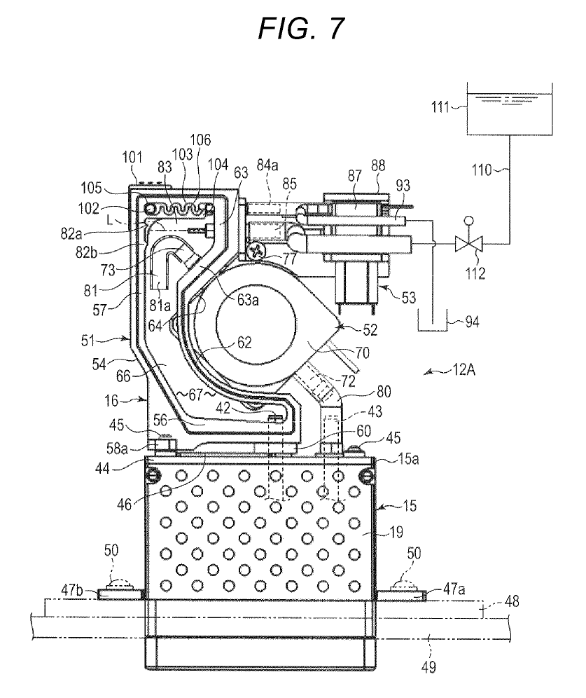

As illustrated in FIGS. 2 and 7, the ink supplying pipe 42 and the ink returning pipe 43 penetrate the top plate 44 and protrude above the end 15a of the ink jet head 15. The ink supplying pipe 42 and the ink returning pipe 43 are arranged in parallel in the longitudinal direction of the top plate 44. The ink supplying pipe 42 is located close to the center of the top plate 44 in the longitudinal direction.

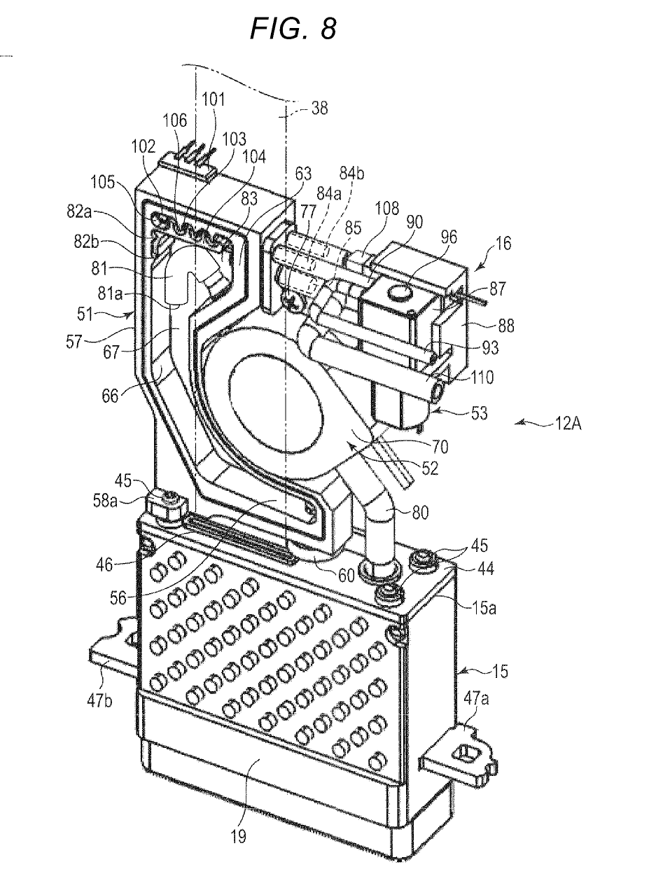

As may be best seen from FIG. 8, the top plate 44 has a slot 46. The slot 46 is a component through which the second printed wiring board 38 is extended to the outside of the ink jet head 15 . The slot 46 extends in the longitudinal direction of the top plate 44, and is offset toward one side of the top plate 44 from the center of the top plate 44 in the lateral direction.

As illustrated in FIGS. 2, 7, and 8, the head main body 17 includes a pair of brackets 47a and 47b. The brackets 47a and 47b horizontally protrude toward the outside of the head cover 19 from both ends of the head cover 19 extending in the longitudinal direction of the head cover 19.

The ink jet head 15 is fixed to a base plate 49 of the ink jet printing apparatus 1 with a frame 48 being disposed between the base plate 49 and the brackets 47a and 47b. The frame 48 is fixed to the lower surfaces of the brackets 47a and 47b via screws 50, and surrounds the lower end of the head cover 19.

According to this embodiment, the driving circuit of the ink jet head 15 applies a driving voltage to the electrodes 35 of the inkjet head 15 based on printing signals input from a controller of the ink jet printing apparatus 1, for example.

As a result, potential differences are generated between the adjoining electrodes 35, whereby electric fields are generated in the partitioning walls 33 corresponding to the electrodes 35. Therefore, the partitioning walls 33 located side by side with the pressure chambers 34 disposed therebetween are curved by shear mode deformation in directions to increase the respective volumes of the pressure chambers 34.

When the driving voltage applied to the electrodes 35 is cut off in the subsequent step, the partitioning walls 33 are displaced in such directions as to return to the initial shapes of the portioning walls 33. The displacement of the portioning walls 33 pressurizes the ink supplied to the pressure chambers 34 from the ink chamber 29. A part of the ink thus pressurized becomes ink drops. The ink drops are ejected from the nozzles 28 toward the sheet S.

On the other hand, the ink circulating device 16 is a component which forcibly circulates ink through the pressure chamber 29 of the ink jet head 15, and may be referred to as an ink circulating module as well. As illustrated in FIGS. 7 through 9, the ink circulating device 16 includes an ink tank 51, a piezoelectric pump 52, and a pressure adjusting mechanism 53.

The ink tank 51 is made of resin material, for example. The ink tank 51 includes a tank main body 54 and a side cover 55. The tank main body 54 includes a bottom part 56 and a rising part 57. The bottom part 56 horizontally extends along the upper surface of the top plate 44.

As illustrated in FIGS. 7 through 10, a pair of support members 58a and 58b is provided at one end of the bottom part 56 of the tank main body 54. The support members 58a and 58b are both fixed to the upper surface of the top plate 44 by using the screws 45. A disk-shaped pedestal 60 is provided at the other end of the bottom part 56. The pedestal 60 is placed on the upper surface of the top plate 44.

The rising part 57 rises from the one end of the bottom part 56. A corner 62 defined by the side surface of the rising part 57 and the upper surface of the bottom part 56 is curved into an arc shape. Moreover, an extension part 63 extending over the corner 62 is provided in the upper part of the rising part 57. A bottom 63a of the extension part 63 is inclined toward the upper end of the corner 62. Accordingly, the corner 62 and the extension part 63 define a recess 64 on one side of the tank main body 54.

The tank main body 54 has a concavity 66 extending from the extension part 63 to the bottom part 56. The concavity 66 opens to the front surface of the tank main body 54. The side cover 55 is bonded to the front surface of the tank main body 54 to cover the concavity 66. The side cover 55 constitutes an ink filling chamber 67 together with the concavity 66.

As illustrated in FIG. 7, the ink supplying pipe 42 of the ink jet head 15 penetrates the pedestal 60 and the bottom part 56 of the tank main body 54 and extends through the bottom of the ink filling chamber 67 in a condition that the tank main body 54 is fixed to the upper surface of the top plate 44.

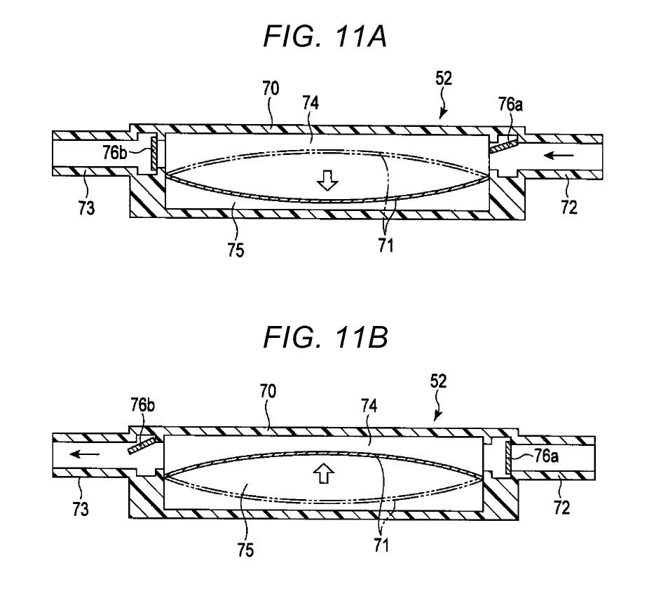

The piezoelectric pump 52 is an example of a circulating pump which forcibly circulates ink between the ink chamber 29 of the ink jet head 15 and the ink tank 51. FIGS. 11A and 11B schematically illustrate an example of the piezoelectric pump 52. As may be seen from FIGS. 11A and 11B, the piezoelectric pump 52 includes a flat pump casing 70, and a film-shaped piezoelectric oscillation element 71 disposed in the pump casing 70.

An ink inlet port 72 and an ink outlet port 73 are formed in the pump casing 70. The ink inlet port 72 and the ink outlet port 73 face to each other, and protrude in the opposite directions from the pump casing 70.

The piezoelectric oscillation element 71 divides the interior of the pump casing 70 into a pump chamber 74 and an atmospheric pressure chamber 75. The ink inlet port 72 communicates with the pump chamber 74 via a first check valve 76a. The ink outlet port 73 communicates with the pump chamber 74 via a second check valve 76b.

As illustrated in FIG. 11A, the piezoelectric oscillation element 71 is caused to deform toward the atmospheric pressure chamber 75 in a suction condition. In this case, the volume of the pump chamber 74 increases and generates a negative pressure of a fluid in the pump chamber 74. As a result, the first check valve 76a opens, while the second check valve 76b closes. Accordingly, ink is sucked into the pump chamber 74 via the ink inlet port 72.

As illustrated in FIG. 11B, the piezoelectric oscillation element 71 is caused to deform toward the pump chamber 74 in an ejection condition. In this case, the ink sucked into the pump chamber 74 is pressurized. As a result, the first check valve 76a closes, while the second check valve 76b opens. Accordingly, the ink pressurized in the pump chamber 74 is ejected from the ink outlet port 73. The operations are repeated to allow continuous ejection of ink from the pump chamber 74.

As illustrated in FIGS. 2, 3, 7, and 8, the piezoelectric pump 52 is supported on the tank main body 54 via a plurality of screws 77 in such a condition that a part of the pump casing 70 enters the recess 64 of the ink tank 51.

In other words, the piezoelectric pump 52 is attached to the tank main body 54 in such a position as to fit within the recess 64 of the ink tank 51. Accordingly, the piezoelectric pump 52 is disposed in a dead space of the tank main body 54 and is integrated with the ink tank 51.

As illustrated in FIG. 7, in a condition that the piezoelectric pump 52 is attached to the ink tank 51, the ink inlet port 72 of the piezoelectric pump 52 extends obliquely downward from the pump casing 70 in the direction toward the ink returning pipe 43 of the ink jet head 15. The ink inlet port 72 and the ink returning pipe 43 are connected by a relay pipe 80.

Moreover, the ink outlet port 73 of the piezoelectric pump 52 extends obliquely upward from the pump casing 70 in the direction toward the extension part 63 of the ink tank 51. The ink outlet port 73 penetrates the bottom 63a of the extension part 63 to be directly disposed into the ink tank 51.

Accordingly, the ink ejected from the ink outlet port 73 of the piezoelectric pump 52 is directly supplied to the ink filling chamber 67 of the ink tank 51. A liquid surface L of the ink stored in the ink filling chamber 67 is higher than the position of the ink outlet port 73.

When an opening of the ink outlet port 73 is located above the liquid surface L of the ink, a ripple is formed on the liquid surface L by the ink ejected from the ink outlet port 73 and air bubbles may be generated. When air bubbles thus generated are mixed into the ink, the bubbles may block the nozzles 28 of the ink jet head 15, and interrupt stable ejection of the ink from the nozzles 28.

To address this problem, in this embodiment, a guide pipe 81 is connected with the ink outlet port 73 inserted into the ink tank 51. The guide pipe 81 is bended downward and extends in the opposite direction within the ink filling chamber 67 such that an opening end 81a of the guide pipe 81 is directed toward the bottom of the ink filling chamber 67.

According to this structure, the ink supplied from the ink outlet port 73 of the piezoelectric pump 52 to the ink filling chamber 67 is guided by the guide pipe 81 and ejected from the opening end 81a of the guide pipe 81 toward the bottom of the ink filling chamber 67. Accordingly, the ink supplied to the ink filling chamber 67 is not discharged on the liquid surface L, and thereby swinging and waving of the liquid surface L can be avoided.

Moreover, a first mark 82a indicating the upper limit of the liquid surface L, and a second mark 82b indicating the lower limit of the liquid surface L are provided in the upper part of the ink filling chamber 67. Each of the first mark 82a and the second mark 82b is a tapered projection projected from the inner surface of the concavity 66.

As illustrated in FIGS. 7 and 8, an air space 83 is formed at the upper end of the ink tank 51. The air space 83 is located in the extension part 63 of the tank main body 54, and faces to the liquid surface L of the ink stored in the ink filling chamber 67.

A pair of vent pipes 84a and 84b and an ink replenishing pipe 85 is attached to the extension part 63 of the tank main body 54. The vent pipes 84a and 84b and the ink replenishing pipe 85 extend to the outside of the ink tank 51. One ends of the vent pipes 84a and 84b are open to the air space 83. One end of the ink replenishing pipe 85 is open to the ink filling chamber 67 in the vicinity of the liquid surface L.

The pressure adjusting mechanism 53 is a component which controls the pressure of ink supplied from the ink filling chamber 67 to the nozzles 28 of the ink jet head 15 by controlling the air pressure of the air space 83.

More specifically, the pressure adjusting mechanism 53 includes a tube pump 87 capable of controlling the negative pressure of the air space 83 by forcibly introducing the air outside the ink tank 51 into the air chamber 83 or releasing the air out of the air space 83. The tube pump 87 is held at the end of a pump holder 88 horizontally extending from the extension part 63 of the tank main body 54 and passing through the piezoelectric pump 52. According to this embodiment, the tube pump 87 faces the extension part 63 of the ink tank 51 with the piezoelectric pump 52 disposed therebetween.

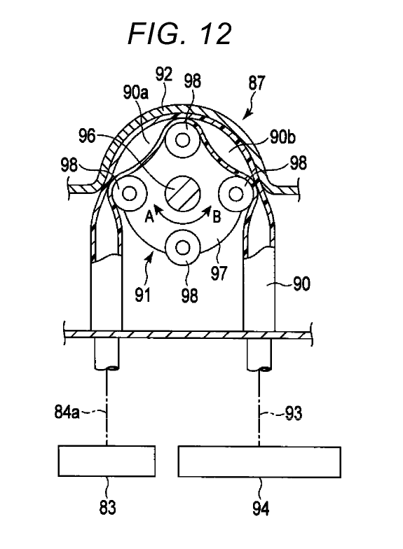

FIG. 12 schematically exemplifies the tube pump 87. As illustrated in FIG. 12, the tube pump 87 includes a tube 90 which has elasticity, and a pressurizing mechanism 91 which presses the tube 90.

The tube 90 is curved along an arc-shaped tube holder 92. One end of the tube 90 communicates with the air space 83 via the one vent pipe 84a. The other end of the tube 90 communicates with an ink recovery tray 94 via an overflow pipe 93, and is open to the atmosphere.

The pressurizing mechanism 91 includes a rotational shaft 96, a roller supporting plate 97, and four pressurizing rollers 98. The rotational shaft 96 is disposed concentrically with the tube holder 92. The roller supporting plate 97 is coaxially fixed to the rotational shaft 96 and rotates together with the rotational shaft 96. The pressurizing rollers 98 are supported on the outer circumferential portion of the roller supporting plate 97, and spaced away from each other in the circumferential direction of the roller supporting plate 97.

When the roller supporting plate 97 rotates in accordance with the rotation of the rotational shaft 96, the plural pressurizing rollers 98 move around the center along the tube holder 92. More specifically, when the roller supporting plate 97 rotates until the three pressurizing rollers 98 come to positions opposing the tube holder 92 as illustrated in FIG. 12, three points of the tube 90 are pressed between the pressurizing rollers 98 and the tube holder 92.

As a result, closed spaces 90a and 90b are formed at adjoining two points of the tube 90 in the length direction thereof. The closed spaces 90a and 90b shift in the length direction of the tube 90 in accordance with the movement of the pressurizing rollers 98 around the center, and are opened to the inner space of the tube 90 when the pressurizing rollers 98 are separated from the tube holder 92.

Accordingly, when the pressurizing rollers 98 move around the center in the direction of an arrow A (clockwise direction) in FIG. 12, the air inside the airspace 83 is taken into the closed spaces 90a and 90b and released in the atmosphere via the overflow pipe 93. As a result, the air in the air space 83 is successively drawn out, whereby negative pressure control for the air space 83 is carried out. The ink contained in the air released to the atmosphere is recovered by the ink recovery tray 94.

On the other hand, when the pressurizing rollers 98 move around the center in the direction of an arrow B (anticlockwise direction) in FIG. 12, the air outside the ink jet head 15 is taken into the closed spaces 90a and 90b of the tube 90 via the overflow pipe 93. The air taken into the closed spaces 90a and 90b is forcibly supplied to the air space 83 via the one vent pipe 84a, and increases the pressure of the air space 83.

As illustrated in FIGS. 7 through 9, a pressure sensor 101 is incorporated in the upper end of the ink tank 51 where the air space 83 is formed. The pressure sensor 101 is a component for detecting the air pressure of the air space 83, and includes a piezoelectric element according to this embodiment. A piezoelectric element, which allows easy adjustment of sensitivity, establishment of settings of the detection range, and the like by changes of the voltage or frequency of the piezoelectric element, easily provides a function of the pressure sensor even when the ink viscosity or ink flow amount varies, for example.

A detection terminal 102 of the pressure sensor 101 is exposed to the end of the air space 83. In this case, the pressure sensor 101 detects a wrong air pressure when liquid such as ink contacts the pressure sensor 101. To avoid this problem, a seal portion 103 having labyrinth structure is provided between the detection terminal 102 of the pressure sensor 101 and the air space 83.

More specifically, a convexity 104 is provided on the inner surface of the tank main body 54 facing the air space 83. The convexity 104 is integrated with the inner surface of the tank main body 54 and extends toward the side cover 55. The seal portion 103 has an insertion hole 105 into which the detection terminal 102 of the pressure sensor 101 is inserted, and a seal groove 106 extending in a winding line.

The insertion hole 105 is open to the tip surface of the convexity 104. The opening end of the insertion hole 105 is closed by the side cover 55. The seal groove 106 is formed in the tip surface of the convexity 104, and closed by the side cover 55. One end of the seal groove 106 communicates with the insertion hole 105, while the other end of the seal groove 106 communicates with the air space 83.

Accordingly, the detection terminal 102 of the pressure sensor 101 detects the actual air pressure of the air space 83 via the seal groove 106. The seal groove 106 is repeatedly bent in a winding line. Thus, when ink stored in the ink tank 51 splashes toward the air space 83, for example, this ink is blocked by the seal groove 106, and thereby prevented from reaching the detection terminal 102 of the pressure sensor 101.

The air pressure of the air space 83 detected by the pressure sensor 101 is fed back to a pump controller included in the pressure adjusting mechanism 53. The air pressure of the air space 83 is proportional to the pressure of the ink supplied to the nozzles 28 of the ink jet head 15. Accordingly, when the air pressure of the air space 83 detected by the pressure sensor 101 is lower than a value determined in advance, the pump controller supplies the air outside the ink jet head 15 to the air space 83 by controlling the tube pump 87.

On the other hand, when the air pressure of the air space 83 detected by the pressure sensor 101 is higher than the value determined beforehand, the pump controller releases the air out of the air space 83 by controlling the tube pump 87.

As a result, the air pressure of the air space 83 is adjusted to the predetermined value, whereby the pressure of the ink supplied to the nozzles 28 of the ink jet head 15 is controlled to become an appropriate value.

When the pressure of the ink supplied to the nozzles 28 is controlled based on the air pressure of the air space 83 as in this embodiment, it is preferable that a control table showing the relationship between the air pressure of the air space 83 and the pressure of ink supplied to the nozzles 28 is prepared based on actual circulation of ink to the ink jet head 15 and that the control table is used for the control of the tube pump 87.

Moreover, two pressure sensors maybe used so as to detect the upstream side and downstream side pressures of the ink chamber 29 of the ink jet head 15, and the pressure of ink supplied to the nozzles 28 may be controlled based on the detection results obtained from the two pressure sensors.

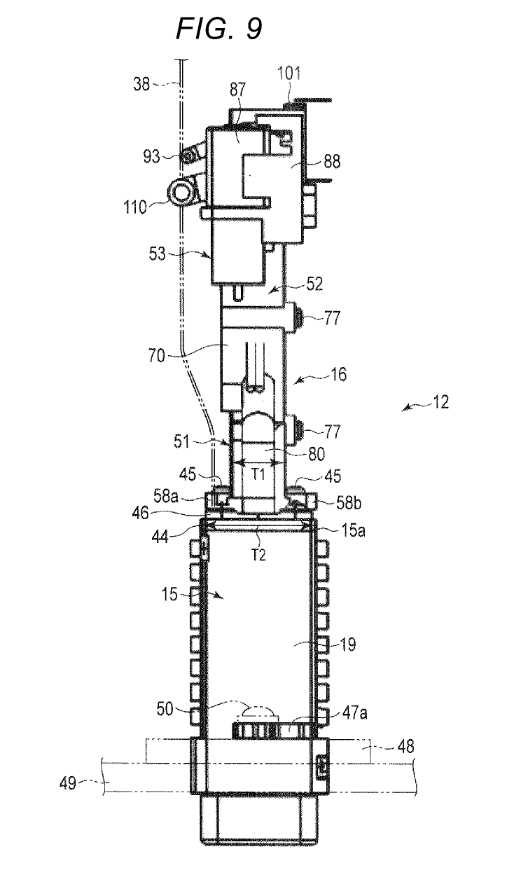

As illustrated in FIGS. 8 and 9, an electromagnetic valve 108 for releasing air to the atmosphere is attached to the vent pipe 84b. The electromagnetic valve 108 is a normally closed type, and operated in the opening direction for opening the air space 83 to the atmosphere when a detection range of the pressure sensor 101 is set.

The ink replenishing pipe 85 extending from the extension part 63 of the tank main body 54 is connected with an ink replenishing tank 111 via an ink replenishing channel 110. The ink replenishing channel 110 includes a normally closed type electromagnetic valve 112. The ink replenishing tank 111 stores replenishing ink, and the pressure inside the tank 111 is maintained at a positive pressure. Accordingly, when the electromagnetic valve 112 is opened, the ink stored in the ink replenishing tank 111 is supplied from the ink replenishing pipe 85 to the ink filing chamber 67 of the ink tank 51.

With supply of the ink to the ink filling chamber 67, the liquid surface L rises, and therefore, the air pressure of the air space 83 increases. In response to the rise of the air pressure of the air space 83, the tube pump 87 starts operation for drawing the air out of the air space 83. As a result, the air pressure of the air space 83 is maintained at the predetermined value.

As illustrated in FIG. 3, the ink circulating device 16 including the ink tank 51, the piezoelectric pump 52, and the pressure adjusting mechanism 53 is contained within the range of a width W between the brackets 47a and 47b of the ink jet head 15.

In other words, the ink circulating device 16 does not largely extend to the area immediately above the brackets 47a and 47b. According to this structure, a tool such as a screwdriver for operating the screws 50 hardly interferes with the ink circulating device 16 upon fixing the brackets 47a and 47b to the frame 48 or releasing the fixation by using the screws 50.

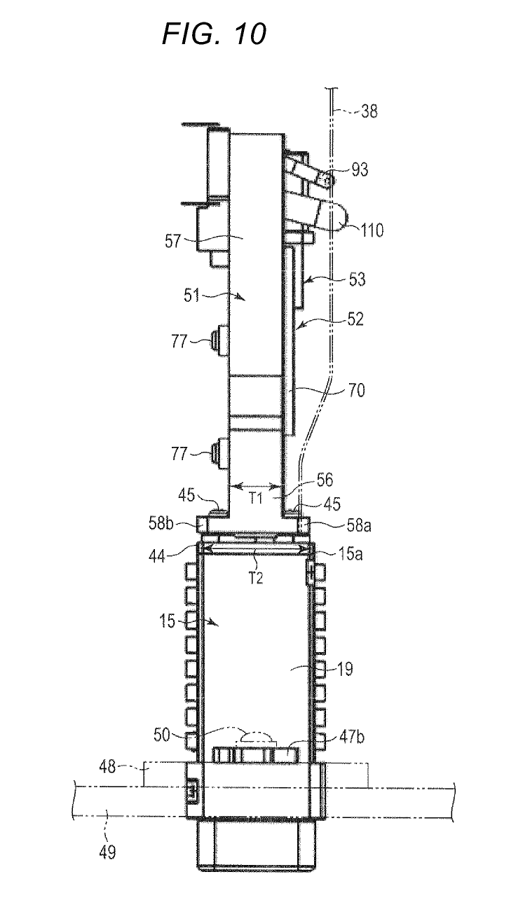

As illustrated in FIGS. 9 and 10, a thickness T1 of the bottom part 56 of the ink tank 51 is smaller than a thickness T2 of the end 15a of the ink jet head 15. Thus, the slot 46 formed in the top plate 44 is located adjacent to the bottom part 56 of the ink tank 51 without being covered by the bottom part 56.

Accordingly, the second flexible printed wiring board 38 extended out of the ink jet head 15 through the slot 46 is extended without being interfered by the ink tank 51.

In response to the operation of the piezoelectric pump 52 in this embodiment, the ink stored in the ink tank 51 of the ink circulating device 16 flows from the ink supplying pipe 42 through the distribution channel 40 of the manifold 18 and the ink supplying ports 24 of the substrate 20, and reaches the ink chamber 29 of the head main body 17 as indicated by the arrows in FIG. 5.

The ink reaching the ink chamber 29 fills the pressure chambers 34 formed in the actuators 23a and 23b and the nozzles 28, and are pressurized in accordance with the operations of the actuators 23a and 23b. A part of the pressurized ink is ejected from the nozzles 28 toward the sheet S as ink drops.

The surplus ink remaining in the pressure chambers 34 without being ejected from the nozzles 28 flows from the pressure chambers 34 through the ink chamber 29 toward the ink discharging ports 25 of the substrate 20 as indicated by the arrows in FIG. 5, and passes through the circulation channel 41 of the manifold 18 and the ink returning pipe 43 to be sucked into the pump chamber 74 of the piezoelectric pump 52 via the ink inlet port 72 thereof.

The ink sucked into the pump chamber 74 is again pressurized by deformation of the piezoelectric oscillation element 71, and fed from the ink outlet port 73 to the ink tank 51. The operations are repeated to circulate ink through the ink chamber 29 of the inkjet head 15. Accordingly, circulated ink is supplied to the nozzles 28 without the ink staying in the vicinity of the nozzles 28 during forming of images.

According to this embodiment, the bottom part 56 of the ink tank 51 constituting the ink circulating device 16 is fixed to the top plate 44 of the ink jet head 15 by the screws 45, while other components such as the piezoelectric pump 52 and the pressure adjusting mechanism 53 are attached to the ink tank 51.

In this case, the components required for circulating ink through the ink chamber 29 of the ink jet head 15 are directly attached to the top plate 44 of the ink jet head 15 and is integrated with the ink jet head 15.

Therefore, it is not necessary to prepare a large-capacity tank storing the circulating ink and pipes for connecting the ink tank and the ink jet head 15. Moreover, it is not necessary to secure a space for providing the ink tank and a space for positioning a large number of pipes around the ink jet head 15.

Accordingly, the structure in this embodiment achieves miniaturization of the first through fourth ink jet devices 12A, 12B, 12C, and 12D while allowing circulation of ink through the ink jet head 15, and therefore contributes to size reduction of the ink jet printing apparatus 1.

Moreover, according to this embodiment, the channels for circulating ink through the ink jet head 15 can be aggregated in the upper part of the ink jet head 15, and thereby the lengths of the channels for ink circulation may be shortened compared to the corresponding lengths in the related art.

As a result, the amount of ink staying in the channels for ink circulation decreases, and therefore both the ink consumption and the amount of ink disposed during maintenance of the ink jet head 15 decrease. Accordingly, the ink jet printing apparatus 1 is capable of lowering the running cost and is economically advantageous.

In addition, the ink tank 51 storing circulating ink is integrated with the ink jet head 15. According to this structure, the amount of ink to fill the ink chamber 29 of the ink jet head 15 at the beginning of printing decreases. Furthermore, filling of ink finishes within a shorter period, wherefore the printing operation can be more rapidly carried out.

While certain embodiments have been described, the embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. An ink jet device, comprising:
an ink jet head having a nozzle thorough which ink is discharged, an ink chamber communicating with the nozzle, an ink inlet from which the ink is supplied to the ink chamber, and an ink outlet from which the ink is recovered from the ink chamber; and
an ink circulating unit having an ink tank that is in close proximity to the ink jet head and is connected to the ink inlet.

2. The inkjet device according to claim 1, wherein the ink tank is directly attached to the ink jet head.

3. The inkjet device according to claim 1, wherein the ink tank supplies the ink to the ink inlet through a pipe that is disposed in an internal space of the ink tank.

4. The ink jet device according to claim 3, wherein the pipe is not exposed to the outside.

5. The inkjet device according to claim 1, wherein the ink circulating unit has a pressure adjusting mechanism configured to adjust a pressure applied to the ink in the ink tank.

6. The inkjet device according to claim 1, wherein the ink tank has a bottom portion in which an opening connected to the ink outlet is formed, the bottom portion extends in a longitudinal direction and a lateral direction, and a length of the bottom portion in the lateral direction is shorter than a length of the ink jet head in the lateral direction.

7. The inkjet device according to claim 6, wherein the ink jet head has a slot extending in the longitudinal direction in an upper surface thereof, and a flexible print circuit extending through the slot and along a peripheral surface of the ink tank.

8. An ink circulating device for an ink jet head, comprising:
an ink tank having a first opening that is disposed at a bottom portion thereof and through which ink is supplied to the ink jet head and a second opening;
a pump unit that is connected to the second opening of the ink tank, has an suction port, and is configured to convey ink from the suction port to the ink tank through the second opening; and
an attachment unit disposed at the bottom portion of the ink tank, to be attached to the ink jet head.

9. The ink circulating device according to claim 8, wherein the pump unit includes a discharging port from which ink taken from the suction port is discharged, and the discharging port is directly connected to the second opening.

10. The ink circulating device according to claim 8, wherein the ink tank has a pedestal around the first opening, and the pedestal is disposed at a same level as the attachment unit.

11. The ink circulating device according to claim 9, further comprising:
a pressure adjusting mechanism configured to adjust a pressure applied to the ink in the ink tank.

12. The ink circulating device according to claim 8, wherein the bottom portion of the ink tank extends in a longitudinal direction and a lateral direction, and the attachment unit is disposed at a longitudinal side of the ink tank.

13. The ink circulating device according to claim 8, wherein the ink tank has a concave portion, and the pomp unit is shaped so as to fit within the concave portion.

14. An ink jet printing apparatus, comprising:
an image forming unit including:
an ink jet head having a nozzle through which ink is discharged, an ink chamber communicating with the nozzle, an ink inlet from which the ink is supplied to the ink chamber, and an ink outlet from which the ink is recovered from the ink chamber, and
an ink circulating unit having an ink tank that is in close proximity to the ink jet head and is connected to the ink inlet; and
a conveying unit configured to convey a sheet along the nozzle.

15. The ink jet printing apparatus according to claim 14, wherein the ink tank is directly attached to the ink jet head.

16. The ink jet printing apparatus according to claim 14, wherein the ink tank supplies the ink to the ink inlet through a pipe that is disposed in an internal space of the ink tank.

17. The ink jet printing apparatus according to claim 16, wherein the pipe is not exposed to the outside.

18. The ink jet printing apparatus according to claim 14, wherein the ink circulating unit has a pressure adjusting mechanism configured to adjust a pressure applied to the ink in the ink tank.

19. The ink jet printing apparatus according to claim 14, wherein the ink tank has a bottom portion in which an opening connected to the ink outlet is formed, the bottom portion extends in a longitudinal direction and a lateral direction, and a length of the bottom portion in the lateral direction is shorter than a length of the ink jet head in the lateral direction.

20. The ink jet printing apparatus according to claim 19, wherein the ink jet head has a slot extending in the longitudinal direction in an upper surface thereof, and a flexible print circuit extending through the slot and along a peripheral surface of the ink tank.
